(19) United States
(12) Patent Application Publication
(10) Pub. No.: US 2025/0052482 A1
(43) Pub. Date: Feb. 13, 2025

(54) REFRIGERATOR AND MANUFACTURING METHOD THEREOF

(71) Applicant: SAMSUNG ELECTRONICS CO., LTD., Suwon-si (KR)

(72) Inventors: Yeonwoo JEONG, Suwon-si (KR); Sunghyun KIM, Suwon-si (KR); Keonpyo KOO, Suwon-si (KR)

(73) Assignee: SAMSUNG ELECTRONICS CO., LTD., Suwon-si (KR)

(21) Appl. No.: 18/753,522

(22) Filed: Jun. 25, 2024

Related U.S. Application Data
(63) Continuation of application No. PCT/KR2024/007476, filed on May 31, 2024.

(30) Foreign Application Priority Data
Aug. 10, 2023 (KR) 10-2023-0105187
Oct. 13, 2023 (KR) 10-2023-0137180

(51) Int. Cl. F25D 23/06

(52) U.S. Cl. CPC F25D 23/063; F25D 2201/10

(57) ABSTRACT

A refrigerator may include a body including a first insulating panel having a first coupler and a second insulating panel having a second coupler, wherein the first coupler and second coupler are coupled together, a compartment inside the body, a door to open and close the compartment, and a cooling device to cool the compartment, wherein the first insulating panel, first coupler, second insulating panel, and second coupler are configured so that, to couple the first coupler and second coupler together, the first insulating panel and first coupler are movable in a first direction toward the second insulating panel and second coupler so that the first coupler and second coupler become engaged, and, after the first coupler and second coupler are engaged, the first insulating panel and first coupler are movable in a second direction perpendicular to the first direction so that the first coupler and second coupler become coupled.

### CROSS-REFERENCE TO RELATED APPLICATIONS

This is a continuation application, under 35 U.S.C. § 111 (a), of International Application PCT/KR2024/007476, filed May 31, 2024, which claims priority under 35 U.S.C. § 119 to Korean Patent Application No. 10-2023-0105187, filed Aug. 10, 2023 and Korean Patent Application No. 10-2023-0137180, filed Oct. 13, 2023, in the Korean Intellectual Property Office, the disclosures of which are incorporated herein in their entireties by reference.

### TECHNICAL FIELD

The present disclosure relates to a refrigerator and a manufacturing method thereof, and more specifically, to a refrigerator in which a main body is formed by assembling a plurality of insulating panels and a manufacturing method thereof.

### BACKGROUND ART

A refrigerator is an apparatus including a main body having a storage compartment, a cold air supply system provided to supply cold air to the storage compartment, and door provided to open and close the storage compartment, thereby keeping food fresh.

Typically, a main body of a refrigerator is manufactured by foaming and hardening a foaming liquid between an inner case made of injection molded resin and an outer case made of metal disposed on the outside of the inner case.

According to this method, due to sizes of the inner and outer cases, a lot of cost, time, and manpower are required to store and transport accessories or to manufacture and manage the main body, and it may be impossible to disassemble the main body again after manufacturing the main body.

### DISCLOSURE

### Technical Problem

The present disclosure is directed to providing a refrigerator formed by assembling a plurality of insulating panels and a manufacturing method thereof.

The present disclosure is directed to providing a refrigerator in which the assembly of a plurality of insulating panels is easy and a coupling force between the plurality of insulating panels is improved and a manufacturing method thereof.

The present disclosure is directed to providing a refrigerator in which thermal deformation due to a temperature inside a storage compartment is minimized and a manufacturing method thereof.

The present disclosure is directed to providing a refrigerator with improved thermal insulation performance and a manufacturing method thereof.

Technical tasks to be achieved in this document are not limited to the technical tasks mentioned above, and other technical tasks not mentioned will be clearly understood by those skilled in the art from the description below.

### Technical Solution

In an aspect of the present disclosure, a refrigerator may include a main body including a first insulating panel having a first coupler and a second insulating panel having a second coupler, wherein the first coupler and the second coupler are coupled together, a storage compartment inside the main body, a door to open and close the storage compartment, and a cooling device to cool the storage compartment, wherein the first insulating panel, the first coupler, the second insulating panel, and the second coupler may be configured so that, to couple the first coupler and the second coupler together, the first insulating panel and first coupler are movable in a first direction toward the second insulating panel and the second coupler so that the first coupler and the second coupler become engaged, and, after the first coupler and the second coupler are engaged, the first insulating panel and the first coupler are movable in a second direction perpendicular to the first direction so that the first coupler and the second coupler become coupled.

One of the first coupler and the second coupler may include a hook, and the other of the first coupler and the second coupler may include a hook coupling part, and the first coupler and the second coupler may be configured so that, to couple the first coupler and the second coupler together, the one of the first coupler and the second coupler which includes the hook is movable in the first direction, or a third direction opposite the first direction, and toward the other of the first coupler and the second coupler which includes the hook coupling part, so that the hook and the hook coupling part become engaged, and, after the hook and hook coupling part are engaged, the one of the first coupler and the second coupler which includes the hook is movable in the second direction, or a fourth direction opposite the second direction, so that the hook and the hook coupling part become coupled.

The hook may include a hook body protruding in the first direction or the third direction, and a hook protrusion extending from an end of the hook body in the second direction or the fourth direction.

The hook coupling part may include an accommodating space configured so that, with the hook and the hook coupling part engaged, the hook is movably accommodated in the accommodating space, an opening formed on a side of the accommodating space and configured so that, with the hook and the hook coupling part coupled, the hook protrusion is received in the opening, and a restraining portion configured so that, with the hook and the hook coupling part coupled, the restraining portion interferes with the hook protrusion to prevent the hook from being separated from the accommodating space by movement in the first direction or the third direction.

The first insulating panel may include an inner case, an outer case coupled to the inner case, and a heat insulator between the inner case and the outer case, the inner case may include a base portion and a step portion protruding from the base portion toward the storage compartment, and the hook may be formed on a surface of the step portion.

The first insulating panel may include a guide protrusion protruding from the step portion, and the second insulating panel may include a guide groove configured so that, with the hook and the hook coupling part engaged or coupled, the guide protrusion is accommodated in the guide groove.

The guide protrusion may extend along one of the second direction and the fourth direction.

The hook may be in contact with the guide protrusion.

The hook may include a plurality of the hooks, and each hook of the plurality of hooks may be spaced apart from each other hook of the plurality of hooks along one of the second direction and the fourth direction.

The first insulating panel may include a first uneven portion on a surface of the first insulating panel, and the second insulating panel may include a second uneven portion on a surface of the second insulating panel and configured to correspond to the first uneven portion so that, as the first coupler and second coupler become engaged, the first uneven portion and the second uneven portion become engaged.

The first uneven portion may include a first convex portion and a first concave portion, the second uneven portion may include a second convex portion configured to be accommodated in the first concave portion and a second concave portion configured to accommodate the first convex portion, and the first uneven portion and the second uneven portion may be configured so that, as the first uneven portion and the second uneven portion become engaged, the second convex portion becomes accommodated in the first concave portion and the first convex portion becomes accommodated in the second concave portion.

The refrigerator may further include a connection bracket configured so that, with the first coupler and the second coupler coupled, the connection bracket is couplable to the first insulating panel and the second insulating panel so that the first insulating panel and the second insulating panel become connected.

The refrigerator may further include a first reinforcing plate inside the first insulating panel and a second reinforcing plate inside the second insulating panel, wherein the first reinforcing plate and the second reinforcing plate may be configured to be couplable to the connection bracket so that, with the first reinforcing plate and the second reinforcing plate coupled to the connection bracket, the first insulating panel and the second insulating panel become connected.

The refrigerator may further include a first fastening member to penetrate the connection bracket and couple to the first reinforcing plate, and a second fastening member to penetrate the connection bracket and couple to the second reinforcing plate, wherein the first fastening member, the first reinforcing plate, the second fastening member, the second reinforcing plate, and the connection bracket may be configured so that, with the first fastening member penetrating the connection bracket and being coupled to the first reinforcing plate, and the second fastening member penetrating the connection bracket and being coupled to the second reinforcing plate, the first insulating panel and the second insulating panel are connected.

Another aspect of the present disclosure provides a refrigerator including a main body formed by assembling a plurality of insulating panels, a storage compartment formed inside the main body, a door provided to open and close the storage compartment, and a cooling device provided to cool the storage compartment, wherein the plurality of insulating panels includes a rear panel, a plurality of side panels, an upper panel, and a lower panel, the plurality of side panels and the rear panel are configured to be coupled to each other through a first movement of the side panels in which the plurality of side panels moves rearward and a second movement of the side panels in which the plurality of side panels moves downward, the upper panel and the plurality of side panels are configured to be coupled to each other through a first movement of the upper panel in which the upper panel moves downward and a second movement of the upper panel in which the upper panel moves rearward, and the lower panel and the plurality of side panels are configured to be coupled to each other through a first movement of the lower panel in which the lower panel moves upward and a second movement of the lower panel in which the lower panel moves rearward.

At least one of the plurality of side panels may include a first coupler, the rear panel may include a second coupler, the first coupler and the second coupler may be coupled to each other through the first movement of the side panel and the second movement of the side panel, the at least one side panel may include a third coupler, the upper panel may include a fourth coupler, the third coupler and the fourth coupler may be coupled to each other through the first movement of the upper panel and the second movement of the upper panel, the at least one side panel may include a fifth coupler, the lower panel may include a sixth coupler, and the fifth coupler and the sixth coupler may be coupled to each other through the first movement of the lower panel and the second movement of the lower panel.

The first coupler, the third coupler, and the fifth coupler may each include a hook body and a hook having a hook protrusion bent and extending from an end of the hook body.

The second coupler, the fourth coupler, and the sixth coupler may each include an accommodating space in which the hook protrusion is movably accommodated, and an opening formed on one side of the accommodating space to allow the hook protrusion to be accommodated in the accommodating space.

The second coupler, the fourth coupler, and the sixth coupler may each include a restraining portion provided to interfere with the hook protrusion to prevent the hook protrusion from being separated from the accommodating space.

Another aspect of the present disclosure provides a refrigerator including a main body formed by assembling a plurality of insulating panels, a storage compartment formed inside the main body, a door provided to open and close the storage compartment, and a cooling device provided to cool the storage compartment, wherein the plurality of insulating panels includes a rear panel, a first side panel, a second side panel, an upper panel, and a lower panel, the first side panel and the rear panel are configured to be coupled to each other through a first movement of the first side panel in which the first side panel moves rearward, and a second movement of the first side panel in which the first side panel moves upward, the second side panel and the rear panel are configured to be coupled to each other through a first movement of the second side panel in which the second side panel moves rearward, and a second movement of the second side panel in which the second side panel moves upward, and the first side panel and the second side panel have a rotationally symmetrical relationship about a central axis perpendicular to the rear panel.

### Advantageous Effects

According to the present disclosure, a main body is formed by assembling a plurality of insulating panels, so a manufacturing method of a refrigerator can be simplified and facilitated.

According to the present disclosure, a coupling strength and coupling durability between the plurality of insulating panels can be improved.

According to the present disclosure, thermal deformation of the main body can be minimized despite a low temperature of a storage compartment.

According to the present disclosure, thermal insulation performance of the refrigerator can be improved.

Effects obtainable from the present disclosure are not limited to the effects mentioned above, and other effects not mentioned will be clearly understood by those skilled in the art from the description below.

### DESCRIPTION OF DRAWINGS

FIG. 1 illustrates a refrigerator according to an embodiment of the present disclosure.

FIG. 2 is an exploded view of the refrigerator according to an embodiment of the present disclosure.

FIG. 3 illustrates a structure in which a plurality of side panels is coupled to a rear panel according to an embodiment of the present disclosure.

FIG. 4 illustrates a structure in which an upper panel and a lower panel are coupled to the plurality of side panels according to an embodiment of the present disclosure.

FIG. 5 illustrates a structure in which hinges and connection brackets are coupled to a plurality of insulating panels according to an embodiment of the present disclosure.

FIG. 6 illustrates a left panel according to an embodiment of the present disclosure.

FIG. 7 illustrates the rear panel according to an embodiment of the present disclosure.

FIG. 8 illustrates the rear panel according to an embodiment of the present disclosure from another angle.

FIG. 9 illustrates a right panel according to an embodiment of the present disclosure.

FIG. 10 is a cross-sectional view illustrating a coupling structure of the left panel and the rear panel according to an embodiment of the present disclosure.

FIG. 11 is another cross-sectional view illustrating the coupling structure of the left panel and the rear panel according to an embodiment of the present disclosure.

FIG. 12 is another cross-sectional view illustrating the coupling structure of the left panel and the rear panel according to an embodiment of the present disclosure.

FIG. 13 illustrates the left panel according to an embodiment of the present disclosure from another angle.

FIG. 14 illustrates the upper panel according to an embodiment of the present disclosure.

FIG. 15 is a cross-sectional view illustrating a coupling structure of the upper panel and the left panel according to an embodiment of the present disclosure.

FIG. 16 is another cross-sectional view illustrating the coupling structure of the upper panel and the left panel according to an embodiment of the present disclosure.

FIG. 17 is another cross-sectional view illustrating the coupling structure of the upper panel and the left panel according to an embodiment of the present disclosure.

FIG. 18 is a cross-sectional view illustrating the coupling structure of the upper panel and the left panel according to an embodiment of the present disclosure, which is taken along line I-I in FIG. 3.

FIG. 19 is a cross-sectional view illustrating the coupling structure of the upper panel and the left panel according to an embodiment of the present disclosure, which is taken along line II-II in FIG. 3 (in a state in which a connection bracket is coupled).

FIG. 20 illustrates a sealing member provided between the plurality of insulating panels according to an embodiment of the present disclosure.

FIG. 21 illustrates the rear panel according to an embodiment of the present disclosure.

FIG. 22 illustrates a structure in which the left panel and the right panel are coupled to the rear panel according to an embodiment of the present disclosure.

### MODE OF THE DISCLOSURE

Various embodiments and terms in this document are not intended to limit the technical features described in this document to specific embodiments, and should be understood to include various modifications, equivalents, or substitutes of the embodiments.

In connection with the description of the drawings, like reference numbers may be used for like or related components.

The singular form of a noun corresponding to an item may include one item or a plurality of items, unless the relevant context clearly dictates otherwise.

In this document, each of phrases such as “A or B,” “at least one of A and B,” “at least one of A or B,” “A, B or C,” “at least one of A, B and C,” and “at least one of A, B, or C” may include any one of the items listed together in the corresponding one of the phrases, or all possible combinations thereof.

The term “and/or” includes any combination of a plurality of related components or any one of a plurality of related components.

Terms such as “first,” “second,” “primary,” and “secondary” may simply be used to distinguish a given component from other corresponding components, and do not limit the corresponding components in any other aspect (e.g., importance or order).

In this specification, the terms “front surface,” “rear surface,” “upper surface,” “lower surface,” “side surface,” “left side,” “right side,” “upper portion,” and “lower portion” used in the following description are defined with reference to the drawings, and the shape and position of each component are not limited by these terms.

The terms “comprises” and “has” are intended to indicate that there are features, numbers, steps, operations, components, parts, or combinations thereof described in this document, and do not exclude the presence or addition of one or more other features, numbers, steps, operations, components, parts, or combinations thereof.

When any component is referred to as being “connected”, “coupled”, “supported” or “in contact” with another component, this includes a case in which the components are indirectly connected, coupled, supported, or in contact with each other through a third component as well as directly connected, coupled, supported, or in contact with each other.

When any component is referred to as being located “on” or “over” another component, this includes not only a case in which any component is in contact with another component but also a case in which another component is present between the two components.

A refrigerator according to an embodiment may include a main body.

The main body may include a heat insulator. The heat insulator may insulate the inside and outside of a storage compartment so that a temperature inside the storage compartment may be kept at a set appropriate temperature without being affected by an external environment of the storage compartment. According to one embodiment, the heat insulator may include a foam heat insulator such as polyurethane foam. According to one embodiment, the heat insulator may further include a vacuum heat insulator in addition to the foam heat insulator, or may be configured as only the vacuum heat insulator instead of the foam heat insulator.

The storage compartment may store various items such as food, medicine, and cosmetics, and may be formed such that at least one side thereof is open to allow items to be put in and to be taken out.

The refrigerator may include one or more storage compartments. When two or more storage compartments are formed in the refrigerator, the respective storage compartments may have different uses and may be kept at different temperatures. To this end, the respective storage compartments may be partitioned from each other by partitions including the heat insulators.

The storage compartment may be provided to be kept at an appropriate temperature range depending on the use, and may include a “refrigerating chamber,” a “freezing chamber,” or a “variable temperature chamber” depending on the use and/or temperature range. The refrigerating chamber may be kept at an appropriate temperature for storing items in a refrigerated state, and the freezing chamber may be kept at an appropriate temperature for storing items in a frozen state. “Refrigerating” may refer to cooling items to the point where the items are not frozen, and as an example, the refrigerating chamber may be kept in a temperature ranging from zero degree Celsius to seven degrees Celsius. “Freezing” may refer to cooling items such that the items are freezing or kept in a frozen state. As an example, the freezing chamber may be kept at a temperature ranging from minus twenty degrees Celsius to minus one degree Celsius. The variable temperature chamber may be used as any one of the refrigerating chamber and the freezing chamber, depending on a selection of a user or regardless of the selection of the user.

In addition to names such as “refrigerating chamber,” “freezing chamber,” and “variable temperature chamber,” the storage compartment may be referred to as various names such as “vegetable chamber,” “fresh chamber,” “cooling chamber,” and “ice making chamber,” terms such as “refrigerating chamber,” “freezing chamber,” and “variable temperature chamber” used below should be understood to encompass storage compartments with corresponding uses and temperature ranges, respectively.

According to one embodiment, the refrigerator may include at least one door configured to open and close the one open side of the storage compartment. The doors may each be provided to open and close the one or more storage compartments, or the one door may be provided to open and close a plurality of the storage compartments. The door may be rotatably or slidingly installed on a front side of the main body.

The door may be configured to seal the storage compartment when closed. Like the main body, the door may include the heat insulator to insulate the storage compartment when closed.

According to one embodiment, the door may include a door outer plate forming a front surface of the door, a door inner plate forming a rear surface of the door and facing the storage compartment, an upper cap, a lower cap, and a door heat insulator provided inside the upper and lower caps.

Edges of the door inner plate may be provided with a gasket sealing the storage compartment by coming into close contact with the front side of the main body when the door is closed. The door inner plate may include a dyke protruding rearward so that a door basket for storing items is mounted.

According to one embodiment, the door may include a door body, and a front panel detachably coupled to a front side of the door body and forming the front surface of the door. The door body may include the door outer plate forming a front surface of the door body, the door inner plate forming a rear surface of the door body and facing the storage compartment, the upper cap, the lower cap, and the door heat insulator provided inside the upper and lower caps.

Refrigerators may be classified into a French door type, a side-by-side type, a bottom mounted freezer (BMF) type, a top mounted freezer (TMF) type, and a one-door refrigerator type depending on the arrangement of doors and storage compartments.

According to one embodiment, the refrigerator may include a cold air supply system configured to supply cold air to the storage compartment.

The cold air supply system may include a machine, mechanism, electronic device, and/or a system combining them capable of generating cold air and guiding the cold air to cool the storage compartment.

According to one embodiment, the cold air supply system may generate cold air through a refrigeration cycle including compression, condensation, expansion, and evaporation processes of a refrigerant. To this end, the cold air supply system may include a refrigeration cycle device having a compressor, a condenser, an expansion device, and an evaporator capable of driving the refrigeration cycle. According to one embodiment, the cold air supply system may include a semiconductor such as a thermoelectric element. The thermoelectric element may cool the storage compartment by generating heat and cooling through the Peltier effect.

According to one embodiment, the refrigerator may include a machine room in which at least some components belonging to the cold air supply system are disposed.

The machine room may be provided to be partitioned and insulated from the storage compartment in order to prevent heat generated from the components disposed in the machine room from being transferred to the storage compartment. The inside of the machine room may be configured to communicate with the outside of the main body to dissipate heat from the components disposed inside the machine room.

According to one embodiment, the refrigerator may include a dispenser provided on the door to provide water and/or ice. The dispenser may be provided on the door such that the user may access the door without opening the door.

According to one embodiment, the refrigerator may include an ice making device provided to produce ice. The ice making device may include an ice making tray provided to store water, an ice moving device provided to separate the ice from the ice making tray, and an ice bucket provided to store the ice produced in the ice making tray.

According to one embodiment, the refrigerator may include a controller configured to control the refrigerator.

The controller may include a memory provided to store or remember programs and/or data for controlling the refrigerator, and a processor provided to output a control signal for controlling a cold air supply system and the like according to the program and/or data stored in the memory.

The memory stores or records various information, data, commands, programs, and the like required for operations of the refrigerator. The memory may remember temporary data generated while generating control signals for controlling components included in the refrigerator. The memory may include at least one of volatile memory and non-volatile memory, or a combination thereof.

The processor controls the overall operation of the refrigerator. The processor can control the components of the refrigerator by executing the programs stored in the memory. The processor may include a separate NPU to perform operations of an artificial intelligence model. The processor may also include a central processor, a graphics processor (GPU), and the like. The processor may generate a control signal for controlling an operation of the cold air supply system. For example, the processor may receive temperature information of the storage compartment from a temperature sensor, and generate a cooling control signal for controlling the operation of the cold air supply system based on the temperature information of the storage compartment.

Additionally, the processor may process user input of a user interface according to the programs and/or data memorized/stored in the memory and control an operation of the user interface. The user interface may be provided using an input interface and an output interface. The processor may receive the user input from the user interface. The processor may also transmit a display control signal and image data for displaying an image on the user interface to the user interface in response to the user input.

The processor and the memory may be provided integrally or may be provided separately. The processor may include one or more processors. For example, the processor may include a main processor and at least one sub-processor. The memory may include one or more memories.

According to one embodiment, the refrigerator may include a processor and a memory to control all the components included in the refrigerator, and may include a plurality of processors and a plurality of memories to individually control the components of the refrigerator. For example, the refrigerator may include a processor and memory to control the operation of the cold air supply system depending on output of the temperature sensor. Also, the refrigerator may be separately equipped with a processor and memory to control the operation of the user interface according to user input.

A communication module may communicate with an external device such as a server, a mobile device, and another home appliance through a nearby access point (AP). The access point (AP) may connect a local area network (LAN) to which the refrigerator or a user device is connected to a wide area network (WAN) to which the server is connected. The refrigerator or the user device may be connected to the server via the wide area network (WAN).

The input interface may include keys, a touch screen, a microphone, and the like. The input interface may receive user input and transmit the user input to the processor.

The output interface may include a display, a speaker, and the like. The output interface may output various notifications, messages, information, and the like generated by the processor.

Hereinafter, preferable embodiments of the present disclosure will be described in detail with reference to the accompanying drawings.

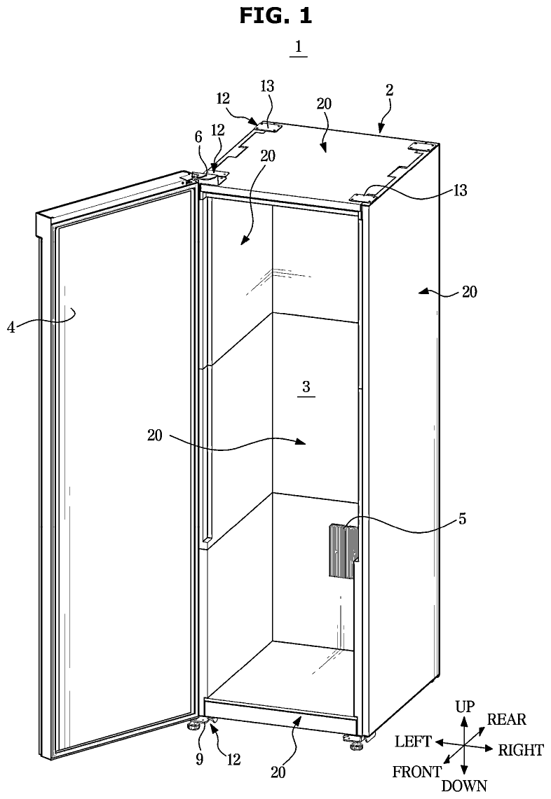

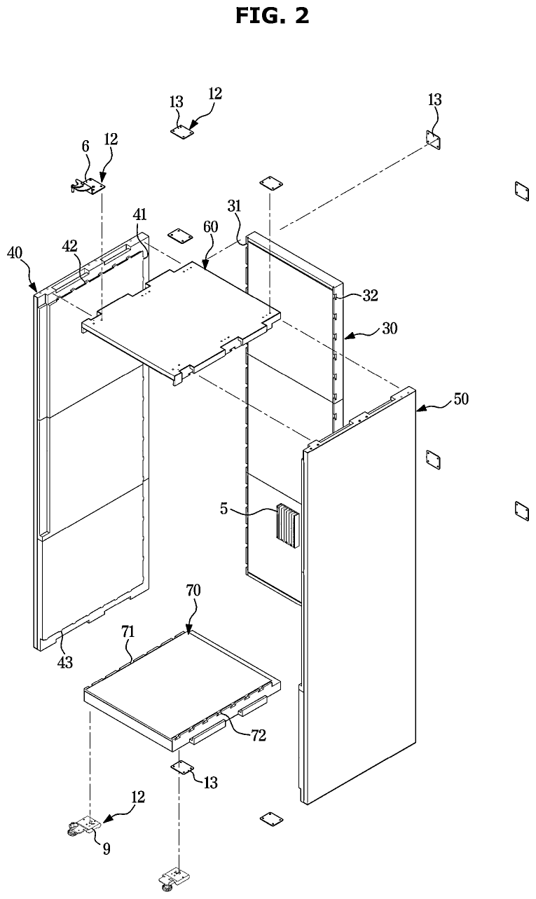

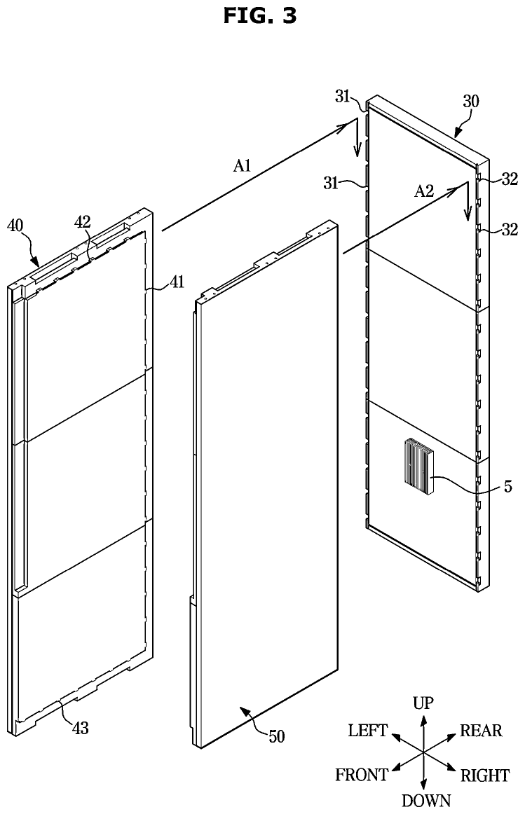

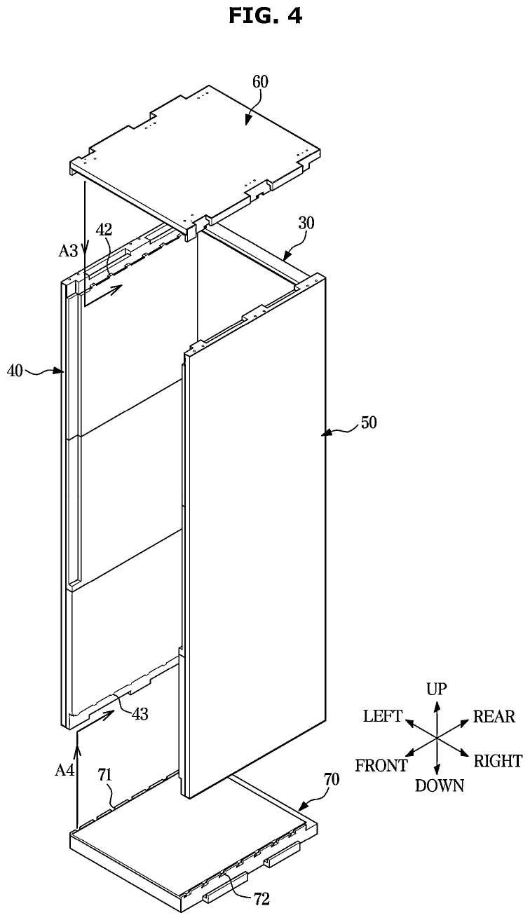

FIG. 1 illustrates a refrigerator according to an embodiment of the present disclosure. FIG. 2 is an exploded view of the refrigerator according to an embodiment of the present disclosure. FIG. 3 illustrates a structure in which a plurality of side panels is coupled to a rear panel according to an embodiment of the present disclosure. FIG. 4 illustrates a structure in which an upper panel and a lower panel are coupled to the plurality of side panels according to an embodiment of the present disclosure.

Referring to FIGS. 1 to 4, a refrigerator 1 may include a main body 2 including a plurality of insulating panels 20, a storage compartment 3 formed inside the main body 2, a door 4 provided to open and close the storage compartment 3, and a cooling device 5 provided to cool the storage compartment 3.

The plurality of insulating panels 20 may be assembled together to form the main body 2 having the storage compartment 3. The storage compartment 3 may store items. The storage compartment 3 may be formed with an open front side to allow the items to be put in the storage compartment 3 or to be taken out the storage compartment 3.

The door 4 may be provided on a front side of the main body 2 to open and close the storage compartment 3. The door 4 may be rotatably coupled to the main body 2 through hinges 6 and 9.

The cooling device 5 may include a thermoelectric module to cool the storage compartment 2 through the Peltier effect. The thermoelectric module may include thermoelectric elements. The thermoelectric element has a heat-absorbing surface and a heat-generating surface, and when a current is applied to the thermoelectric element, heat moves from the heat-absorbing surface to the heat-generating surface, which may cause a temperature difference between the heat-absorbing surface and the heat-generating surface. That is, heat may be generated from the heat-generating surface and the heat may be absorbed from the heat-absorbing surface. The thermoelectric element may be disposed so that the heat-absorbing surface faces the storage compartment 3 and the heat-generating surface faces the outside of the main body. The thermoelectric module may include a cooling sink attached to the heat-absorbing surface to efficiently absorb heat, and a heat sink attached to the heat-generating surface to efficiently generate heat.

The cooling device 5 may be provided on the at least one insulating panel 20 among the plurality of insulating panels 20. The drawing illustrates that the cooling device 5 is provided on a rear panel 30, but the cooling device 5 is not limited thereto and may be provided on another insulating panel.

Additionally, the cooling device 5 is not limited to the thermoelectric module and may include a refrigeration cycle device to generate cold air through a refrigeration cycle including compression, condensation, expansion, and evaporation processes of the refrigerant.

Each of the plurality of insulating panels 20 may have a substantially rectangular parallelepiped shape. Each of the plurality of insulating panels 20 may include a heat insulator therein. The heat insulator may include a foam heat insulator such as polyurethane foam. Or, the heat insulator may further include a vacuum heat insulator in addition to the foam heat insulator, or may be configured as only the vacuum heat insulator instead of the foam heat insulator. The plurality of insulating panels 20 may each include an inner case forming the storage compartment and an outer case coupled to the inner case. The inner case may be made of a resin material, and the outer case may be made of a metal material. An internal space is formed between the inner case and the outer case, and the heat insulator may be disposed in the internal space.

The plurality of insulating panels 20 may include the rear panel 30, a plurality of side panels 40 and 50, an upper panel 60, and a lower panel 70. The plurality of side panels 40 and 50 may include the left panel 40 and the right panel 50. The rear panel 30 may form a rear surface of the main body 2. The left panel 40 may form a left surface of the main body 2. The right panel 50 may form a right surface of the main body 2. The upper panel 60 may form an upper surface of the main body 2. The lower panel 70 may form a lower surface of the main body 2.

The left panel 40 may be coupled to a left end of the rear panel 30 through a double sliding movement.

That is, as illustrated by arrow A1 in FIG. 3, the left panel 40 and the rear panel 30 may be coupled through a first movement in which the left panel 40 moves rearward and a second movement in which the left panel 40 moves downward after the first movement.

To this end, the left panel 40 may include a left panel rear coupler 41 and the rear panel 30 may include a rear panel left coupler 31.

The left panel rear coupler 41 and the rear panel left coupler 31 may be coupled through a first movement in which the left panel rear coupler 41 moves rearward toward the rear panel left coupler 31 so that the left panel rear coupler 41 and the rear panel left coupler 31 become engaged, and a second movement in which the left panel rear coupler 41 moves downward after the first movement so that the left panel rear coupler 41 and the rear panel left coupler 31 become coupled.

The right panel 50 may be coupled to a right end of the rear panel 30 through a double sliding movement.

That is, as illustrated by arrow A2 in FIG. 3, the right panel 50 and the rear panel 30 may be coupled through a first movement in which the right panel 50 moves rearward and a second movement in which the right panel 50 moves downward after the first movement.

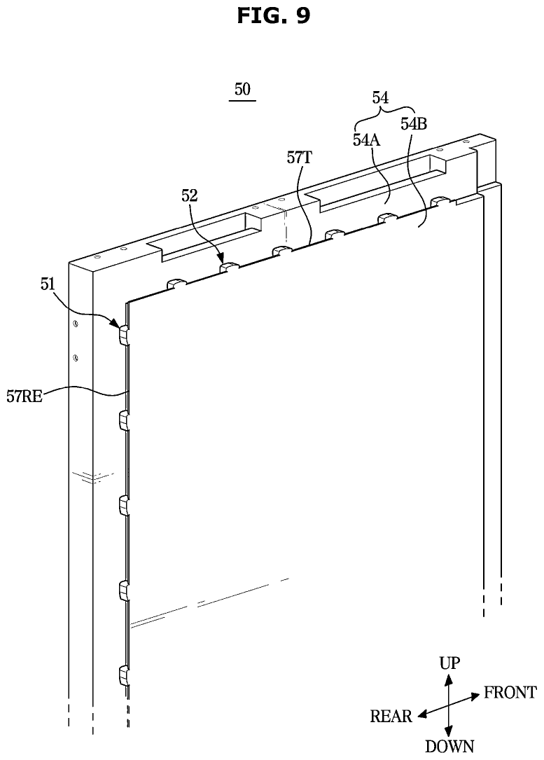

To this end, the right panel 50 may include a right panel rear coupler 51 (FIG. 9) and the rear panel 30 may include a rear panel right coupler 32.

The right panel rear coupler 51 and the rear panel right coupler 32 may be coupled through a first movement in which the right panel rear coupler 51 moves rearward toward the rear panel right coupler 32 so that right panel rear coupler 51 and the rear panel right coupler 32 become engaged, and a second movement in which the right panel rear coupler 51 moves downward after the first movement so that the right panel rear coupler 51 and the rear panel right coupler 32 become coupled.

The upper panel 60 may be coupled to an upper end of the left panel 40 and an upper end of the right panel 50 through a double sliding movement.

That is, as illustrated by arrow A3 in FIG. 4, the upper panel 60 and the left panel 40 may be coupled through a first movement in which the upper panel 60 moves downward and a second movement in which the upper panel 60 moves rearward after the first movement. Also, the upper panel 60 and the right panel 50 may be coupled through the first movement in which the upper panel 60 moves downward and the second movement in which the upper panel 60 moves rearward after the first movement.

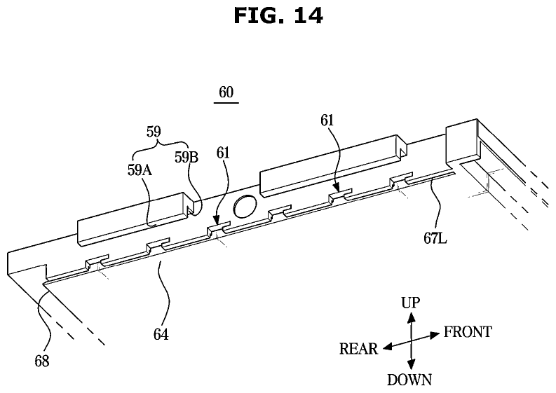

To this end, the upper panel 60 may include an upper panel left coupler 61 (FIG. 14) and the left panel 40 may include a left panel upper coupler 42. Also, the upper panel 60 may include an upper panel right coupler (not shown), and the right panel 50 may include a right panel upper coupler 52 (FIG. 9).

The upper panel left coupler 61 and the left panel upper coupler 42 may be coupled through a first movement in which the upper panel left coupler 61 moves downward toward the left panel upper coupler 42 so that the upper panel left coupler 61 and the left panel upper coupler 42 become engaged, and a second movement in which the upper panel left coupler 61 moves rearward after the first movement so that the upper panel left coupler 61 and the left panel upper coupler 42 become coupled.

The upper panel right coupler (not shown) and the right panel upper coupler 52 (FIG. 9) may be coupled through a first movement in which the upper panel right coupler (not shown) moves downward toward the right panel upper coupler 52 so that the upper panel right coupler (not shown) and the rear panel upper coupler 52 become engaged, and a second movement in which the upper panel right coupler (not shown) moves rearward after the first movement so that the upper panel rear coupler (not shown) and the rear panel upper coupler 52 become coupled.

The lower panel 70 may be coupled to a lower end of the left panel 40 and a lower end of the right panel 50 through a double sliding movement.

That is, as illustrated by arrow A4 in FIG. 4, the lower panel 70 and the left panel 40 may be coupled through a first movement in which the lower panel 70 moves upward and a second movement in which the lower panel 70 moves rearward after the first movement. Also, the lower panel 70 and the right panel 50 may be coupled through the first movement in which the lower panel 70 moves upward and the second movement in which the lower panel 70 moves rearward after the first movement.

To this end, the lower panel 70 may include a lower panel left coupler 71 and the left panel 40 may include a left panel lower coupler 43. Also, the lower panel 70 may include a lower panel right coupler 72, and the right panel 50 may include a right panel lower coupler (not shown).

The lower panel left coupler 71 and the left panel lower coupler 43 may be coupled through a first movement in which the lower panel left coupler 71 moves upward toward the left panel lower coupler 43 so that the lower panel left coupler 71 and the left panel rear coupler 43 become engaged, and a second movement in which the lower panel left coupler 71 moves rearward after the first movement so that the lower panel left coupler 71 and the left panel rear coupler 43 become coupled.

The lower panel right coupler 72 and the right panel lower coupler (not shown) may be coupled through a first movement in which the lower panel right coupler 72 moves upward toward the right panel lower coupler (not shown) so that the lower panel right coupler 72 and the right panel lower coupler (not shown) become engaged, and a second movement in which the lower panel right coupler 72 moves rearward after the first movement so that the lower panel right coupler 72 and the right panel lower coupler (not shown) become coupled.

Such as, by coupling the plurality of insulating panels to each other with a double sliding structure, a coupling strength between the plurality of insulating panels may be increased, and the insulating panels may not be deformed even after long-term use. In addition, the coupling strength may be prevented from weakening due to thermal deformation due to a low temperature of storage compartment 2.

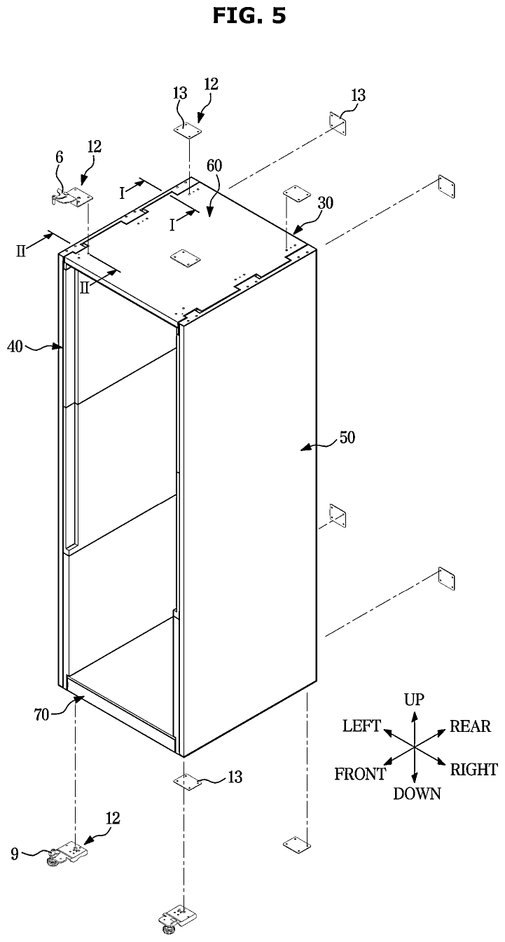

FIG. 5 illustrates a structure in which hinges and connection brackets are coupled to a plurality of insulating panels according to an embodiment of the present disclosure.

The refrigerator 1 may include connection brackets 12 provided to connect the plurality of insulating panels 20. The connection bracket 12 may include hinges 6 and 9 and a bracket 13. The hinges 6 and 9 may be provided with a hinge shaft forming a rotation axis of the door 4. The bracket 13 may be formed in a flat shape. The connection bracket 12 may be attached to an outer surface of the main body 2.

In the drawing, four of the connection brackets 12 are provided at upper corners of the main body 2, four of the connection brackets 12 are provided at rear corners of the main body 2, and four of the connection brackets 12 are provided at lower corners of the main body 2, but the number and position of the connection brackets 12 are not limited thereto.

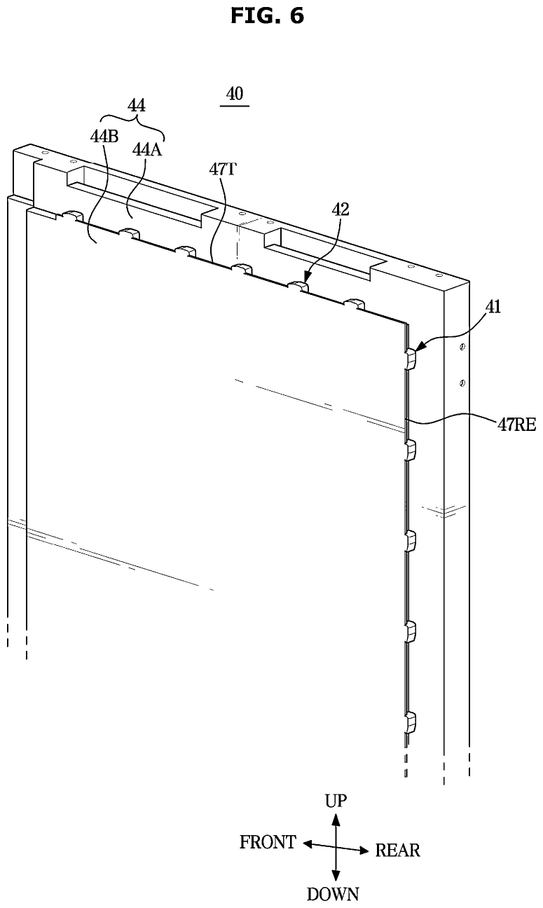

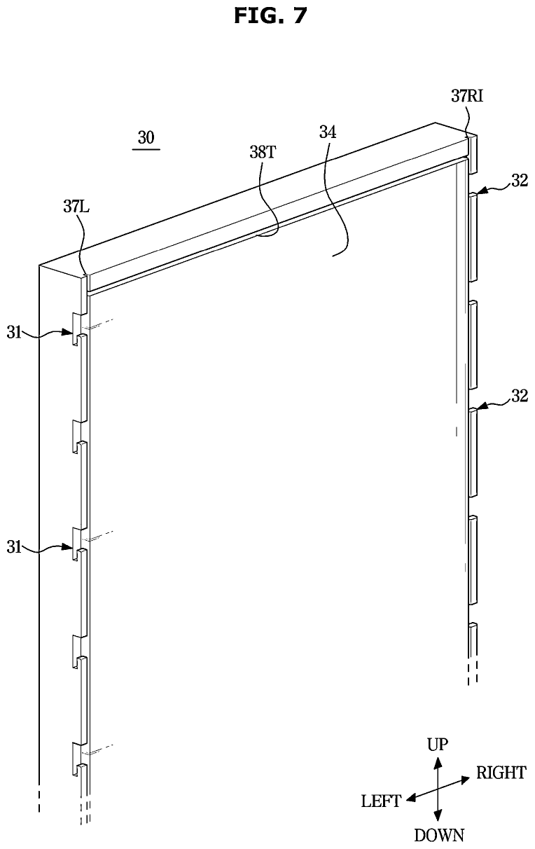

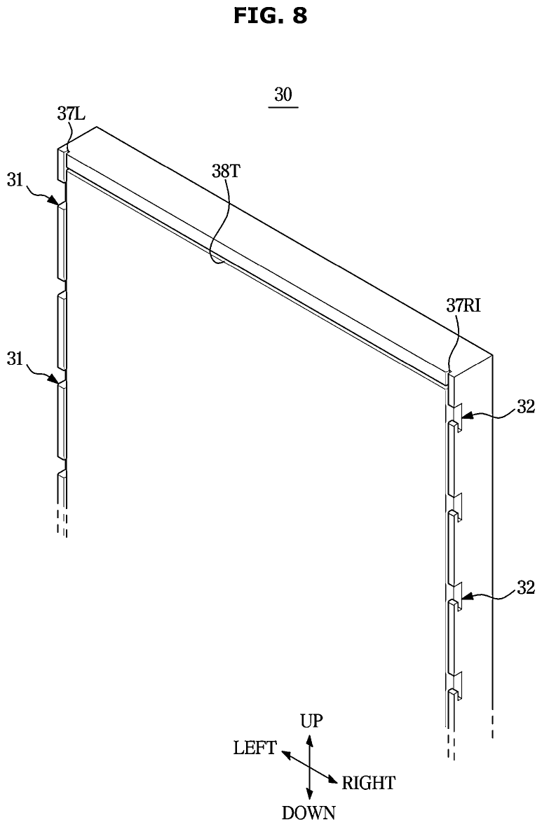

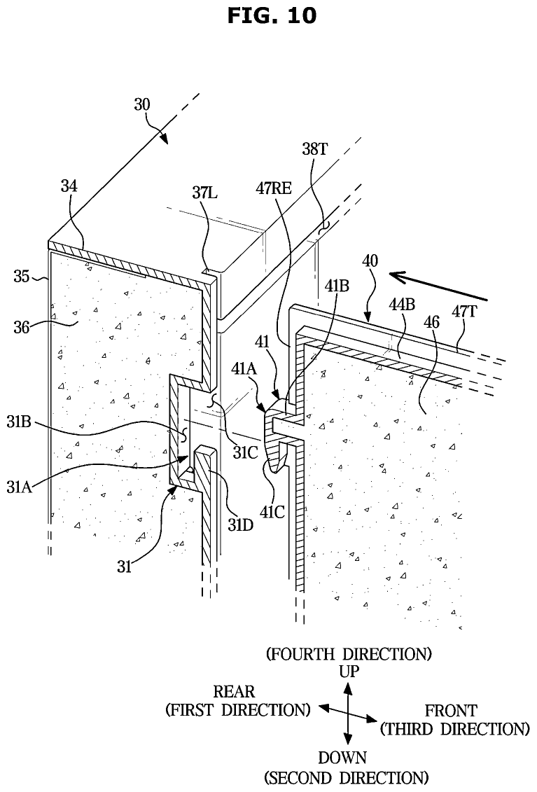

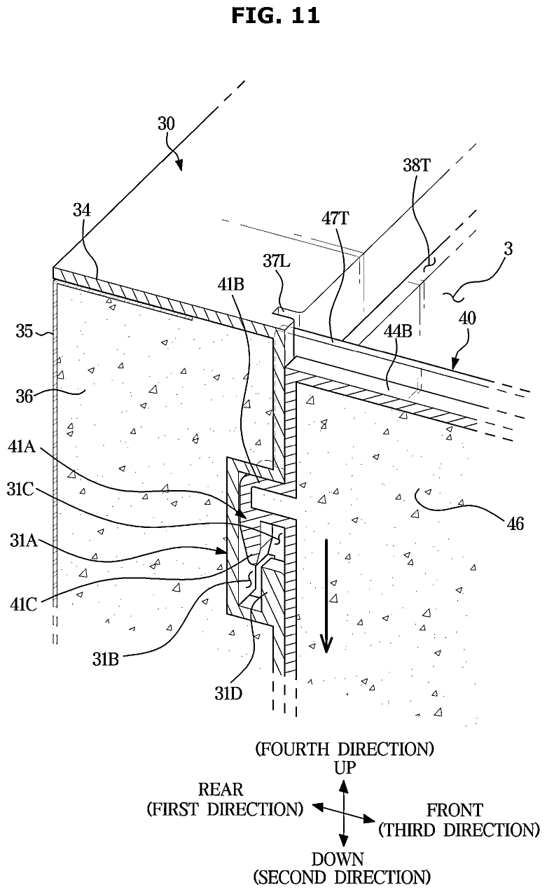

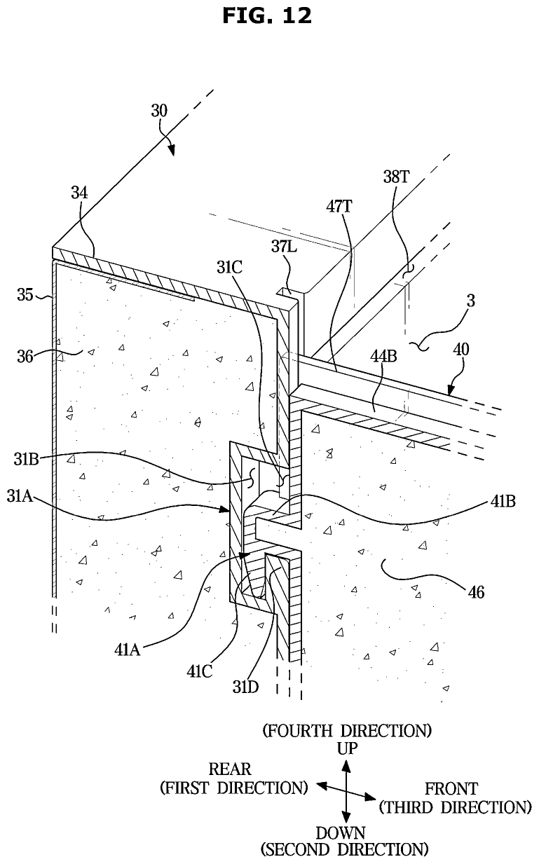

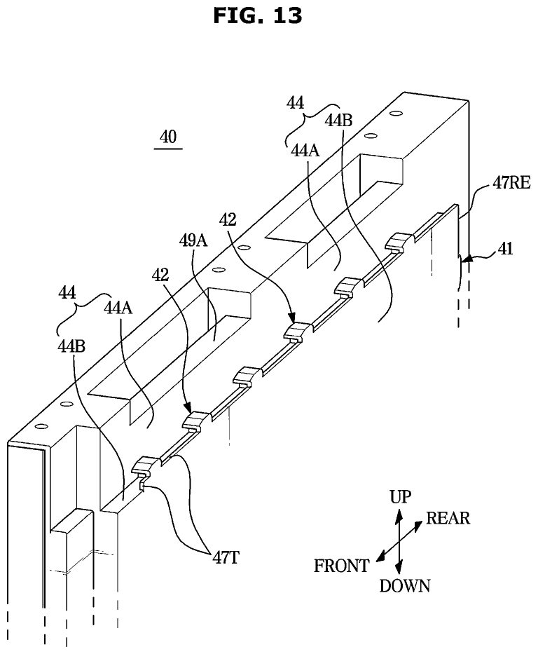

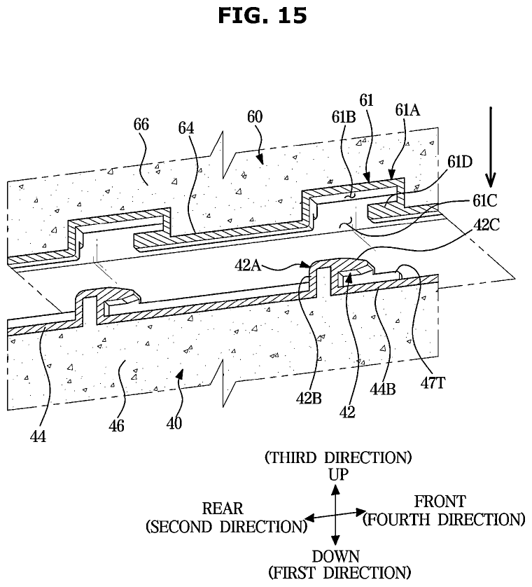

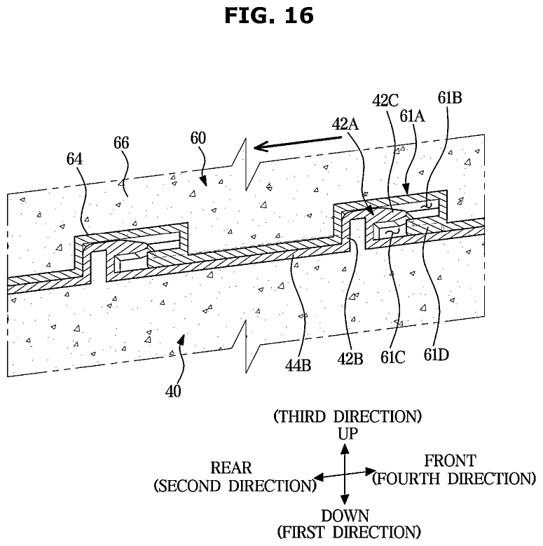

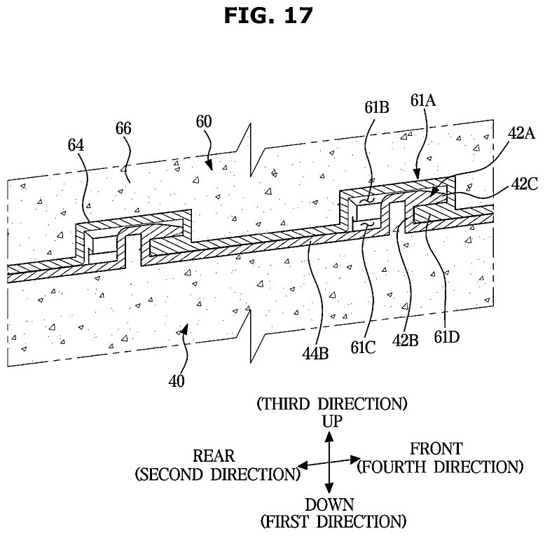

FIG. 6 illustrates a left panel according to an embodiment of the present disclosure. FIG. 7 illustrates the rear panel according to an embodiment of the present disclosure. FIG. 8 illustrates the rear panel according to an embodiment of the present disclosure from another angle. FIG. 9 illustrates a right panel according to an embodiment of the present disclosure. FIG. 10 is a cross-sectional view illustrating a coupling structure of the left panel and the rear panel according to an embodiment of the present disclosure. FIG. 11 is another cross-sectional view illustrating the coupling structure of the left panel and the rear panel according to an embodiment of the present disclosure. FIG. 12 is another cross-sectional view illustrating the coupling structure of the left panel and the rear panel according to an embodiment of the present disclosure. FIG. 13 illustrates the left panel according to an embodiment of the present disclosure from another angle. FIG. 14 illustrates the upper panel according to an embodiment of the present disclosure. FIG. 15 is a cross-sectional view illustrating a coupling structure of the upper panel and the left panel according to an embodiment of the present disclosure. FIG. 16 is another cross-sectional view illustrating the coupling structure of the upper panel and the left panel according to an embodiment of the present disclosure. FIG. 17 is another cross-sectional view illustrating the coupling structure of the upper panel and the left panel according to an embodiment of the present disclosure.

A specific structure of the left panel rear coupler 41 and the rear panel left coupler 31 and a specific coupling structure of the left panel 40 and the rear panel 30 will be described below with reference to FIGS. 2 to 17.

The above-described couplers 31, 32, 41, 42, 43, 51, 52, 61, 71, and 72 may each include a hook or a hook coupling part to which the hook is coupled.

The hook may include a hook body protruding in one direction and a hook protrusion extending in a direction perpendicular to the one direction from an end of the hook body. That is, the hook protrusion may be bent and extend from the end of the hook body.

The hook coupling part may include an accommodating space in which the hook protrusion is movably accommodated, an opening formed on one side of the accommodating space to allow the hook protrusion to be accommodated in the accommodating space, and a restraining portion provided to interfere with the hook protrusion to prevent the hook protrusion from being separated from the accommodating space.

As an example, referring to FIGS. 2 and 9, the left panel rear coupler 41 may include a hook, and the rear panel left coupler 31 may include a hook coupling part.

The right panel rear coupler 51 (FIG. 9) may include a hook, and the rear panel right coupler 32 may include a hook coupling part.

The upper panel left coupler 61 may include a hook coupling part, and the left panel upper coupler 42 may include a hook.

The upper panel right coupler (not shown) may include a hook coupling part, and the right panel upper coupler 52 (FIG. 9) may include a hook coupling part.

The lower panel left coupler 71 may include a hook coupling part, and the left panel lower coupler 43 may include a hook.

The lower panel right coupler 72 may include a hook coupling part, and the right panel lower coupler (not shown) may include a hook.

However, the present disclosure is not limited thereto, and the couplers to be coupled to each other may include opposite configurations. That is, it is sufficient for one of the couplers to be coupled to each other to include a hook and the other one to include a hook coupling part.

A coupling structure of the left panel rear coupler 41 of the left panel 40 and the rear panel left coupler 31 of the rear panel 30 will be described below with reference to FIGS. 10 to 12. In FIGS. 10 to 12, a rearward direction may be referred to as a first direction, a downward direction may be referred to as a second direction, a forward direction may be referred to as a third direction, and an upward direction may be referred to as a fourth direction.

The left panel 40 may be coupled to the left end of the rear panel 30 through the double sliding movement.

The left panel 40 may include the left panel rear coupler 41, and the rear panel 30 may include the rear panel left coupler 31.

The left panel rear coupler 41 and the rear panel left coupler 31 may be coupled through the first movement in which the left panel rear coupler 41 moves rearward (in the first direction) toward the rear panel left coupler 31 so that the left panel rear coupler 41 and the rear panel left coupler 31 become engaged, and the second movement in which the left panel rear coupler 41 moves downward (in the second direction) after the first movement so that the left panel rear coupler 41 and the rear panel left coupler 31 become coupled.

The left panel rear coupler 41 may include a hook 41A. The hook 41A may include a hook body 41B protruding in one direction, and a hook protrusion 41C extending in a direction perpendicular to the one direction from an end of the hook body 41B.

The hook body 41B may protrude rearward (in the first direction). The hook protrusion 41C may extend downward (in the second direction) from the end of the hook body 41B.

The rear panel left coupler 31 may include a hook coupling part 31A. The hook coupling part 31A may include an accommodating space 31B in which the hook protrusion 41C is movably accommodated, an opening 31C formed on one side of the accommodating space 31B to allow the hook protrusion 41C to be accommodated in the accommodating space 31B, and a restraining portion 31D provided to interfere with the hook protrusion 41C to prevent the hook protrusion 41C from being separated from the accommodating space 31B.

The opening 31C may be formed to correspond to or be slightly larger than a size of the hook protrusion 41C to allow the hook protrusion 41C to pass therethrough. The accommodating space 31B may be formed to be longer than the opening 31C so that the hook protrusion 41C is movable upward and downward (in the second and fourth directions). The restraining portion 31D may be formed below (on the second direction side) the opening 31C.

With this configuration, by the first movement in which the hook 41A moves rearward (in the first direction) toward the hook coupling part 31A, the hook protrusion 41C may pass through the opening 31C to be accommodated on an upper side of the accommodating space 31B so that the hook 41A and the hook coupling part 31A are engaged (FIG. 11).

By the second movement in which the hook 41A moves downward (in the second direction) after the first movement, the hook protrusion 41C may be accommodated on a lower side of the accommodating space 31B to be restrained in the restraining portion 31D, so that the hook protrusion 41C may be prevented from being separated forward (in the third direction) and the hook 41A and the hook coupling part 31A are coupled (FIG. 12).

The right panel rear coupler 51 (FIG. 9) and the left panel rear coupler 41 may have a left-right symmetrical relationship. Also, the rear panel right coupler 32 and the rear panel left coupler 31 may have a left-right symmetrical relationship.

Therefore, a coupling structure of the right panel rear coupler 51 (FIG. 9) and the rear panel right coupler 32 is the same as the coupling structure of the left panel rear coupler 41 and the rear panel left coupler 31 described above, and thus a description thereof will be omitted.

Reference numerals 34, 35, and 36 in FIGS. 10 to 12, which are not described, refer to the inner case 34, the outer case 35, and the heat insulator 36 of the rear panel 30, respectively.

A coupling structure of the upper panel left coupler 61 of the upper panel 60 and the left panel upper coupler 42 of the left panel 40 will be described below with reference to FIGS. 15 to 17. In FIGS. 15 to 17, the downward direction may be referred to as a first direction, the rearward direction may be referred to as a second direction, the upward direction may be referred to as a third direction, and the forward direction may be referred to as a fourth direction.

The upper panel 60 may be coupled to the upper end of the left panel 40 through a double sliding movement.

The upper panel 60 may include the upper panel left coupler 61, and the left panel 40 may include the left panel upper coupler 42.

The upper panel left coupler 61 and the left panel upper coupler 42 may be coupled through the first movement in which the upper panel left coupler 61 moves downward (in the first direction) toward the left panel upper coupler 42 so that the upper panel left coupler 61 and the left panel upper coupler 42 become engaged, and the second movement in which the upper panel left coupler 61 moves rearward (in the second direction) after the first movement so that the upper panel left coupler 61 and the left panel upper coupler 42 become coupled.

The left panel upper coupler 42 may include a hook 42A. The hook 42A may include a hook body 42B protruding in one direction, and a hook protrusion 42C extending in a direction perpendicular to the one direction from an end of the hook body 42B.

The hook body 42B may protrude upward (in the third direction). The hook protrusion 42C may extend forward (in the fourth direction) from the end of the hook body 42B.

The upper panel left coupler 61 may include a hook coupling part 61A. The hook coupling part 61A may include an accommodating space 61B in which the hook protrusion 42C is movably accommodated, an opening 61C formed on one side of the accommodating space 61B to allow the hook protrusion 42C to be accommodated in the accommodating space 61B, and a restraining portion 61D provided to interfere with the hook protrusion 42C to prevent the hook protrusion 42C from being separated from the accommodating space 61B.

The opening 61C may be formed to correspond to or be slightly larger than a size of the hook protrusion 42C to allow the hook protrusion 42C to pass therethrough. The accommodating space 61B may be formed to be longer than the opening 61C so that the hook protrusion 42C is movable forward and rearward (in the second and fourth directions). The restraining portion 61D may be formed in the front (on the fourth direction side) of the opening 61C.

With this configuration, by the first movement in which the hook coupling part 61A moves upward (in the first direction) toward the hook 42A, the hook protrusion 42C may pass through the opening 61C to be accommodated on a rear side of the accommodating space 61B so that the hook 42A and the hook coupling part 61A are engaged (FIG. 16). By the second movement in which the hook coupling part 61A moves rearward (in the second direction), the hook protrusion 42C may be accommodated on a front side of the accommodating space 61B to be restrained in the restraining portion 61D, so that the hook protrusion 42C may be prevented from being separated downward (in the third direction) and the hook 42A and the hook coupling part 61A are coupled (FIG. 17).

A coupling structure of the upper panel right coupler (not shown) and the right panel upper coupler 52 is substantially the same as the coupling structure of the upper panel left coupler 61 and the left panel upper coupler 42 described above, and thus a description thereof will be omitted.

In addition, because a coupling structure of the lower panel 70 and the left panel 40 is vertically symmetrical to the coupling structure of the upper panel 60 and the left panel 40 described above, and a coupling structure of the lower panel 70 and the right panel 50 is vertically symmetrical to the coupling structure of the upper panel 60 and the right panel 50 described above, a description thereof will be omitted.

The left panel 40 and right panel 50 may include guide protrusions.

Specifically, the left panel 40 may include a rear guide protrusion 47RE (FIGS. 6 and 13). The left panel 40 may include an upper guide protrusion 47T (FIGS. 6 and 13). The left panel 40 may include a lower guide protrusion (not shown).

The rear guide protrusion 47RE of the left panel 40 may extend long in an up-down direction. The upper guide protrusion 47T and the lower guide protrusion (not shown) of the left panel 40 may extend long in a front-rear direction.

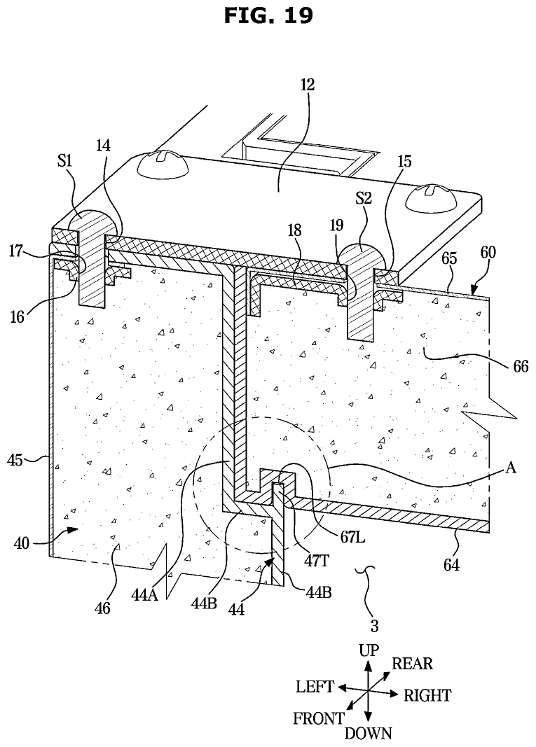

The rear guide protrusion 47RE of the left panel may be inserted into and accommodated in a guide groove 37L (FIGS. 7 and 8) formed to be recessed in the rear panel 30. The upper guide protrusion 47T of the left panel may be inserted into and accommodated in a guide groove 67L (FIG. 19) formed to be recessed in the upper panel 60. The lower guide protrusion (not shown) of the left panel may be inserted into and accommodated in a guide groove (not shown) formed to be recessed in the lower panel 70.

The right panel 50 may include a rear guide protrusion 57RE (FIG. 9). The right panel 50 may include an upper guide protrusion 57T (FIG. 9). The right panel 50 may include a lower guide protrusion (not shown).

The rear guide protrusion 57RE of the right panel 50 may extend long in the up-down direction. The upper guide protrusion 57T and the lower guide protrusion (not shown) of the right panel 50 may extend long in the front-rear direction.

The rear guide protrusion 57RE of the right panel may be inserted into and accommodated in a guide groove 37RI (FIGS. 7 and 8) formed to be recessed in the rear panel 30. The upper guide protrusion 57T of the right panel may be inserted into and accommodated in a guide groove (not shown) formed to be recessed in the upper panel 60. The lower guide protrusion (not shown) of the right panel may be inserted into and accommodated in a guide groove (not shown) formed to be recessed in the lower panel 70.

The rear guide protrusion 47RE of the left panel 40 may guide the left panel rear coupler 41 to slide downward to be coupled to the rear panel left coupler 31.

The upper guide protrusion 47T of the left panel 40 may guide the upper panel left coupler 61 to slide rearward to be coupled to the left panel upper coupler 42.

The lower guide protrusion (not shown) of the left panel 40 may guide the lower panel left coupler 71 to slide rearward to be coupled to the left panel lower coupler 43.

The rear guide protrusion 57RE of the right panel 50 may guide the right panel rear coupler 51 (FIG. 9) to slide downward to be coupled to the rear panel right coupler 32.

The upper guide protrusion 57T of the right panel 50 may guide the upper panel right coupler (not shown) to slide rearward to be coupled to the right panel upper coupler 52 (FIG. 9).

The lower guide protrusion (not shown) of the right panel 50 may guide the lower panel right coupler 72 to slide rearward to be coupled to the right panel lower coupler (not shown).

As such, because the guide protrusions 47RE, 47T, 57RE, and 57T are inserted into and accommodated in the guide grooves 37L, 37RI, and 67L, the coupling force between the insulating panels may be strengthened and the storage compartment 3 may be further sealed, thereby preventing cold air in the storage compartment 3 from leaking to the outside. In particular, the guide protrusions 47RE, 47T, 57RE, and 57T may be effective in minimizing heat shrinkage of the inner case of the insulating panels due to the low temperature of the storage compartment 3.

As illustrated in FIGS. 13 and 19, the left panel 40 may include an inner case 44 forming the storage compartment 3, an outer case 45, and heat insulators 46 provided inside the inner case 44 and the outer case 45.

The inner case 44 may include a base portion 44A and a step portion 44B protruding from the base portion 44A toward the storage compartment 3. The step portion 44B may protrude from the base portion 44A to have a predetermined thickness. The step portion 44B may have an upper surface, a rear surface, a lower surface, a front surface, and an inner surface facing the storage compartment.

The above-described left panel rear coupler 41, left panel upper coupler 42, and left panel lower coupler 43 may be formed on the step portion 44B.

Specifically, the left panel rear coupler 41 may be formed on the rear surface of the step portion 44B. The left panel upper coupler 42 may be formed on the upper surface of the step portion 44B. The left panel lower coupler 43 may be formed on the lower surface of the step portion 44B.

The left panel rear coupler 41 may be configured as a plurality of the left panel rear couplers 41, and the plurality of left panel rear couplers 41 may be formed on the rear surface of the step portion 44B to be spaced apart from each other in the up-down direction.

The left panel upper coupler 42 may be configured as a plurality of the left panel upper couplers 42, and the plurality of left panel upper couplers 42 may be formed on the upper surface of the step portion 44B to be spaced apart from each other in the front-rear direction.

The left panel lower coupler (not shown) may be configured as a plurality of the left panel lower couplers (not shown), and the plurality of left panel lower couplers (not shown) may be formed on the lower surface of the step portion 44B to be spaced apart from each other in the front-rear direction.

Also, the above-described rear guide protrusion 47RE, upper guide protrusion 47T, and lower guide protrusion (not shown) of the left panel 40 may be formed on the step portion 44B.

Specifically, the rear guide protrusion 47RE of the left panel 40 may be formed on the rear surface of the step portion 44B. The upper guide protrusion 47T of the left panel 40 may be formed on the upper surface of the step portion 44B. The lower guide protrusion (not shown) of the left panel 40 may be formed on the lower surface of the step portion 44B.

The rear guide protrusion 47RE, the upper guide protrusion 47T, and the lower guide protrusion (not shown) may be formed on the same plane as the inner surface of the step portion 44B.

The left panel rear coupler 41 and the rear guide protrusion 47RE may be formed to be in contact with each other. The left panel upper coupler 42 and the upper guide protrusion 47T may be formed to be in contact with each other. The left panel lower coupler 43 and the lower guide protrusion (not shown) may be formed to be in contact with each other. With this configuration, the rigidity of both the couplers and the guide protrusions may be increased.

The right panel 50 may include an inner case 54 forming the storage compartment 3, an outer case 55, and heat insulators provided inside the inner case 54 and the outer case 55.

As illustrated in FIG. 9, the inner case 54 may include a base portion 54A and a step portion 54B protruding from the base portion 54A toward the storage compartment 3. The step portion 54B may protrude from the base portion 54A to have a predetermined thickness. The step portion 54B may have an upper surface, a rear surface, a lower surface, a front surface, and an inner surface facing the storage compartment.

The above-described right panel rear coupler 51, right panel upper coupler 52, and right panel lower coupler (not shown) may be formed on the step portion 54B.

Specifically, the right panel rear coupler 51 may be formed on the rear surface of the step portion right 54B. The right panel upper coupler 52 may be formed on the upper surface of the step portion 54B. The right panel lower coupler (not shown) may be formed on the lower surface of the step portion 54B.

The right panel rear coupler 51 may be configured as a plurality of the right panel rear couplers 51, and the plurality of right panel rear couplers 51 may be formed on the rear surface of the step portion 54B to be spaced apart from each other in the up-down direction.

The right panel upper coupler 52 may be configured as a plurality of the right panel upper couplers 52, and the plurality of right panel upper couplers 52 may be formed on the upper surface of the step portion 54B to be spaced apart from each other in the front-rear direction.

The right panel lower coupler (not shown) may be configured as a plurality of the right panel lower couplers (not shown), and the plurality of right panel lower couplers (not shown) may be formed on the lower surface of the step portion 54B to be spaced apart from each other in the front-rear direction.

Also, the above-described rear guide protrusion 57RE, upper guide protrusion 57T, and lower guide protrusion (not shown) of the right panel 50 may be formed on the base portion 54A.

Specifically, the rear guide protrusion 57RE of the right panel 50 may be formed on the rear surface of the step portion 54B. The upper guide protrusion 57T of the right panel 50 may be formed on the upper surface of the step portion 54B. The lower guide protrusion (not shown) of the right panel 50 may be formed on the lower surface of the step portion 54B.

The rear guide protrusion 57RE, the upper guide protrusion 57T, and the lower guide protrusion (not shown) may be formed on the same plane as the inner surface of the step portion 54B.

The right panel rear coupler 51 and the rear guide protrusion 57RE may be formed to be in contact with each other. The right panel upper coupler 52 and the upper guide protrusion 57T may be formed to be in contact with each other. The right panel lower coupler (not shown) and the lower guide protrusion (not shown) may be formed to be in contact with each other. With this configuration, the rigidity of both the couplers and the guide protrusions may be increased.

The upper panel 60 may include a support protrusion 68 (FIG. 14) protruding from a rear end of the upper panel 60. The support protrusion 68 may extend long in a left-right direction. The support protrusion 68 may be inserted into and accommodated in a support groove 38T (FIGS. 7 and 8) formed to be recessed in the rear panel 30. By the structure of the support protrusion 68 and the support groove 38T, the coupling force between the insulating panels may be strengthened and the sealing of the storage compartment 3 may be increased.

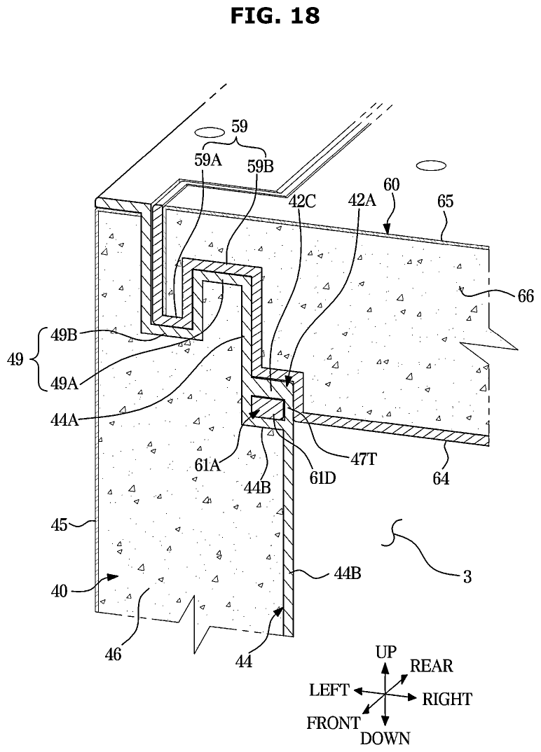

FIG. 18 is a cross-sectional view illustrating the coupling structure of the upper panel and the left panel according to an embodiment of the present disclosure, which is taken along line I-I in FIG. 5.

Referring to FIG. 18 and the like, the upper panel 60 may include first uneven portions 59 formed on the left and right sides of the upper panel 60. The first uneven portion 59 may include a first convex portion 59A and a first concave portion 59B.

The left panel 40 and the right panel 50 may include second uneven portions 49 provided to be engaged with the first uneven portions 59 of the upper panel 60, respectively. The second uneven portion 49 may include a second concave portion 49B in which the first convex portion 59A is accommodated, and a second convex portion 49A inserted into the first concave portion 59B.

Through these structures of the first uneven portions 59 and the second uneven portions 49, the coupling force between the insulating panels may be strengthened and the storage compartment 2 may be sealed more efficiently.

FIG. 19 is a cross-sectional view illustrating the coupling structure of the upper panel and the left panel according to an embodiment of the present disclosure, which is taken along line II-II in FIG. 5 (in a state in which a connection bracket is coupled).

Referring to FIG. 19, the connection bracket 12 may be provided on the outer surface of the main body 2 to connect the plurality of insulating panels. The connection bracket 12 may be made of a rigid metal material.

As an example, the connection bracket 12 is provided on an upper side of the outer surface of the main body 2 to connect the left panel 40 and the upper panel 60. One side of the connection bracket 12 may be fastened to the left panel 40 through a fastening member S1 such as a screw. The other side of the connection bracket 12 may be fastened to the upper panel 60 through a fastening member S2 such as a screw. To this end, a passing hole 14 through which the fastening member S1 penetrates and a passing hole 15 through which the fastening member S2 penetrates may be formed on the connection bracket 12.

A reinforcing plate 16 having a fastening hole 17 into which the fastening member S1 is fastened may be provided inside the left panel 40. A reinforcing plate 18 having a fastening hole 19 into which the fastening member S2 is fastened may be provided inside the upper panel 60.

As the fastening member S1 penetrates the connection bracket 12 to be fastened to the first reinforcing plate 16 of the left panel 40 and the fastening member S2 penetrates the connection bracket 12 to be fastened to the second reinforcing plate 18 of the upper panel 60, the coupling force between the left panel 40 and the upper panel 60 may be strengthened.

Reference numerals 64, 65, and 66 in FIGS. 15 to 19, which are not described, refer to the inner case 64, the outer case 65, and the heat insulator 66 of the upper panel 60, respectively.

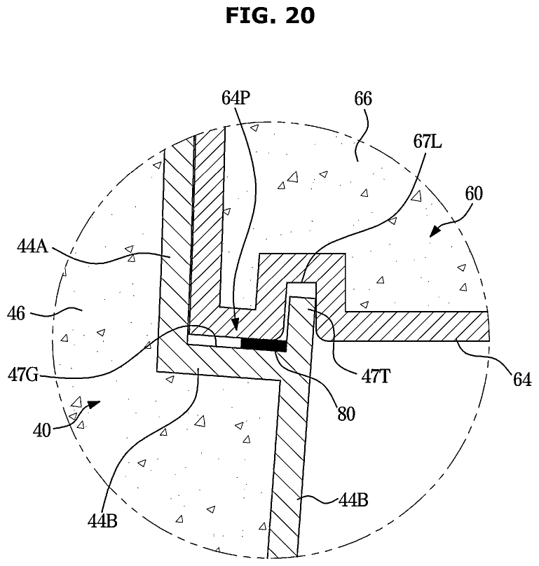

FIG. 20 illustrates a sealing member provided between the plurality of insulating panels according to an embodiment of the present disclosure.

According to an embodiment of the present disclosure, a sealing member 80 may be provided between the plurality of insulating panels. The sealing member 80 may be provided between adjacent insulating panels among the plurality of insulating panels.

FIG. 20 illustrates as an example that the sealing member 80 is provided between the upper panel 60 and the left panel 40. However, the sealing member 80 may also be provided between other adjacent insulating panels, such as between the upper panel 60 and the right panel 50, between the upper panel 60 and the rear panel 30, between the lower panel 70 and the left panel 40, between the lower panel 70 and the right panel 50, and between the lower panel 70 and the rear panel 30. In the following, an example in which the sealing member 80 is provided between the upper panel 60 and the left panel 40 will be described, and descriptions of examples in which the sealing member 80 is provided in other positions will be omitted.

The left panel 40 may include an insertion groove 47G formed by the upper guide protrusion 47T, the step portion 44B of the inner case 44, and the base portion 44A of the inner case 44, the upper panel 60 may include an insertion protrusion 64P inserted into the insertion groove 47G, and the sealing member 80 may be provided in the insertion groove 47G to be in close contact with the insertion protrusion 64P.

The sealing member 80 may be made of an elastic rubber material. The sealing member 80 may be in a compressed state at an initial stage of assembly of the left panel 40 and the upper panel 60. That is, the sealing member 80 may be in a state in which an elastic force is accumulated by being compressed by the pressure of the left panel 40 and the upper panel 60 in the initial stage of assembly.

As illustrated in FIG. 20, due to the low temperature of the storage compartment or a weight of the door acting on the insulating panels for a long period of time, deformation such as bending occurs in the insulating panels, and accordingly, when lifting occurs between the insulating panels, the sealing member 80 may be restored to an original state thereof and the occurrence of a gap between the insulating panels may be prevented.

As such, according to the embodiment of the present disclosure, because the sealing member 80 is provided between the couplers of the insulating panels, even when deformation occurs in the insulating panels, a gap between the couplers of the insulating panels may be sealed, and cold air in the storage compartment may be prevented from leaking to the outside.

Unlike the embodiment of FIG. 20, the sealing member 80 may be provided between the upper guide protrusion 47T of the left panel 40 and the guide groove 67L of the upper panel 60. Also, the sealing member 80 may be provided between the first uneven portion 59 of the upper panel 60 and the second uneven portion 49 of the left panel 40.

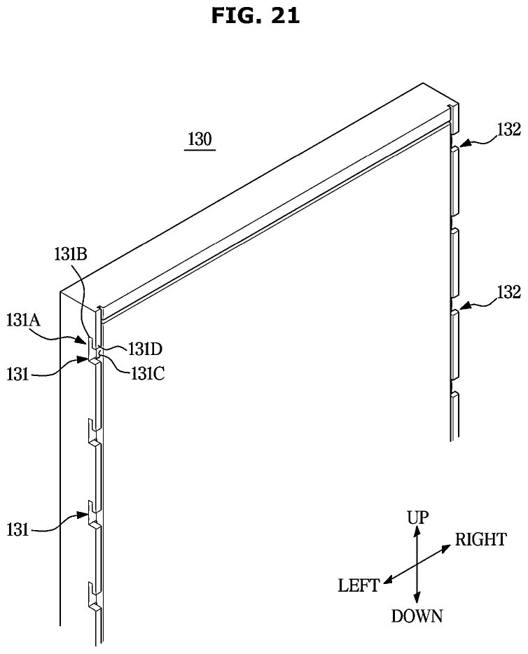

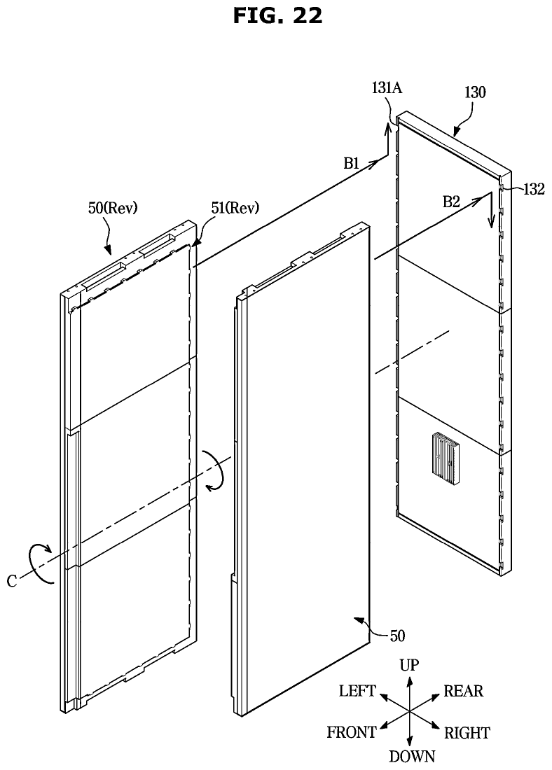

FIG. 21 illustrates the rear panel according to an embodiment of the present disclosure. FIG. 22 illustrates a structure in which the left panel and the right panel are coupled to the rear panel according to an embodiment of the present disclosure.

A structure in which the left panel and the right panel may be used in common will be described below with reference to FIGS. 21 and 22.

The same reference numerals are assigned to the same components as that in the above-described embodiment, and descriptions thereof may be omitted.

According to the above-described embodiment (FIGS. 7 and 8), the rear panel left coupler 31 and the rear panel right coupler 32 have a left-right symmetric relationship with each other.

However, according to the embodiment of FIGS. 21 and 22, a rear panel left coupler 131 and a rear panel right coupler 132 of a rear panel 130 may have a shape of being turned upside down about a central vertical axis of the rear panel 130.

That is, the rear panel left coupler 131 of the rear panel 130 may include a hook coupling part 131A to which a left panel rear coupler 51 (REV) of a left panel 50 (REV) is coupled, and the hook coupling part 131A may include an accommodating space 131B, an opening 131C formed on one side of the accommodating space 131B, and a restraining portion 131D.

In particular, the restraining portion 131D may be positioned above the opening 131C, unlike in the above-described embodiment (FIGS. 7 and 8).

On the other hand, the rear panel right coupler 132 of the rear panel 130 may include a hook coupling part 132A, and the hook coupling part 132A may include an accommodating space, an opening formed on one side of the accommodating space, and a restraining portion.

The restraining portion of the rear panel right coupler 132 may be positioned below the opening, as in the above-described embodiment (FIGS. 7 and 8).

In addition, as illustrated in FIG. 22, the left panel 50 (REV) and the right panel 50 may have a relationship that is rotationally symmetrical by 180 degrees about a central axis C perpendicular to the rear panel 130.

That is, the left panel rear coupling coupler 51 (REV) of the left panel 50 (REV) may have a hook protrusion extending upward, and the right panel rear coupler of the right panel 50 may have a hook protrusion extending downward.

With this structure, as illustrated by arrow B1 in FIG. 22, the left panel 50 (REV) may be coupled to the rear panel 130 through a first movement in which the left panel 50 (REV) moves rearward and a second movement in which the left panel 50 (REV) moves upward, and as illustrated by arrow B2 in FIG. 22, the right panel 50 may be coupled to the rear panel 130 through the first movement in which the right panel 50 moves rearward and the second movement in which the right panel 50 moves downward.

As a result, because the left panel 50 (REV) and the right panel 50 have the relationship that is rotationally symmetrical by 180 degrees about the central axis C perpendicular to the rear panel 130, the right panel 50 may be used instead of the left panel 50 (REV), and the left panel 50 (REV) may be used instead of the right panel 50.

Although the technical idea of the present disclosure as described above has been described through specific embodiments, the scope of the present disclosure is not limited to these embodiments. Various other embodiments that may be modified or changed by those skilled in the art within the scope of not departing from the gist of the technical idea of the present disclosure specified in the claims will also fall within the scope of the present disclosure.

1. A refrigerator comprising:
a main body including a first insulating panel having a first coupler and a second insulating panel having a second coupler, wherein the first coupler and the second coupler are coupled together;
a storage compartment inside the main body;
a door to open and close the storage compartment; and
a cooling device to cool the storage compartment,
wherein the first insulating panel, the first coupler, the second insulating panel, and the second coupler are configured so that, to couple the first coupler and the second coupler together, the first insulating panel and first coupler are movable in a first direction toward the second insulating panel and the second coupler so that the first coupler and the second coupler become engaged, and, after the first coupler and the second coupler are engaged, the first insulating panel and the first coupler are movable in a second direction perpendicular to the first direction so that the first coupler and the second coupler become coupled.

2. The refrigerator according to claim 1, wherein
one of the first coupler and the second coupler includes a hook,
the other of the first coupler and the second coupler includes a hook coupling part, and
the first coupler and the second coupler are configured so that, to couple the first coupler and the second coupler together, the one of the first coupler and the second coupler which includes the hook is movable in the first direction, or a third direction opposite the first direction, and toward the other of the first coupler and the second coupler which includes the hook coupling part, so that the hook and the hook coupling part become engaged, and, after the hook and hook coupling part are engaged, the one of the first coupler and the second coupler which includes the hook is movable in the second direction, or a fourth direction opposite the second direction, so that the hook and the hook coupling part become coupled.

3. The refrigerator according to claim 2, wherein
the hook includes:
a hook body protruding in the first direction or the third direction; and
a hook protrusion extending from an end of the hook body in the second direction or the fourth direction.

4. The refrigerator according to claim 3, wherein
the hook coupling part includes:
an accommodating space configured so that, with the hook and the hook coupling part engaged, the hook is movably accommodated in the accommodating space;
an opening formed on a side of the accommodating space and configured so that, with the hook and the hook coupling part coupled, the hook protrusion is received in the opening; and
a restraining portion configured so that, with the hook and the hook coupling part coupled, the restraining portion interferes with the hook protrusion to prevent the hook from being separated from the accommodating space by movement in the first direction or the third direction.

5. The refrigerator according to claim 2, wherein
the first insulating panel includes an inner case, an outer case coupled to the inner case, and a heat insulator between the inner case and the outer case,
the inner case includes a base portion and a step portion protruding from the base portion toward the storage compartment, and
the hook is formed on a surface of the step portion.

6. The refrigerator according to claim 5, wherein
the first insulating panel includes a guide protrusion protruding from the step portion, and
the second insulating panel includes a guide groove configured so that, with the hook and the hook coupling part engaged or coupled, the guide protrusion is accommodated in the guide groove.

7. The refrigerator according to claim 6, wherein
the guide protrusion extends along one of the second direction and fourth direction.

8. The refrigerator according to claim 6, wherein
the hook is in contact with the guide protrusion.

9. The refrigerator according to claim 6, wherein
the hook includes a plurality of the hooks, and
each hook of the plurality of hooks is spaced apart from each other hook of the plurality of hooks along one of the second direction and the fourth direction.

10. The refrigerator according to claim 1, wherein
the first insulating panel includes a first uneven portion on a surface of the first insulating panel, and
the second insulating panel includes a second uneven portion on a surface of the second insulating panel and configured to correspond to the first uneven portion so that, as the first coupler and second coupler become engaged, the first uneven portion and the second uneven portion become engaged.

11. The refrigerator according to claim 10, wherein
the first uneven portion includes a first convex portion and a first concave portion,
the second uneven portion includes a second convex portion configured to be accommodated in the first concave portion and a second concave portion configured to accommodate the first convex portion, and
the first uneven portion and the second uneven portion are configured so that, as the first uneven portion and the second uneven portion become engaged, the second convex portion becomes accommodated in the first concave portion and the first convex portion becomes accommodated in the second concave portion.

12. The refrigerator according to claim 1, further comprising:
a connection bracket configured so that, with the first coupler and the second coupler coupled, the connection bracket is couplable to the first insulating panel and the second insulating panel so that the first insulating panel and the second insulating panel become connected.

13. The refrigerator according to claim 12, further comprising:
a first reinforcing plate inside the first insulating panel; and
a second reinforcing plate inside the second insulating panel,
wherein the first reinforcing plate and the second reinforcing plate are configured to be couplable to the connection bracket so that, with the first reinforcing plate and the second reinforcing plate coupled to the connection bracket, the first insulating panel and the second insulating panel become connected.

14. The refrigerator according to claim 13, further comprising:
a first fastening member to penetrate the connection bracket and couple to the first reinforcing plate, and
a second fastening member to penetrate the connection bracket and couple to the second reinforcing plate,
wherein the first fastening member, the first reinforcing plate, the second fastening member, the second reinforcing plate, and the connection bracket are configured so that, with the first fastening member penetrating the connection bracket and being coupled to the first reinforcing plate, and the second fastening member penetrating the connection bracket and being coupled to the second reinforcing plate, the first insulating panel and the second insulating panel are connected.
